(19) United States
(12) Patent Application Publication
(10) Pub. No.: US 2020/0124340 A1
(43) Pub. Date: Apr. 23, 2020

(54) REFRIGERATING AND FREEZING DEVICE

(71) Applicant: QINGDAO HAIER JOINT STOCK CO., LTD., Qingdao City, Shandong Province (CN)

(72) Inventors: SONGZHI TANG, Qingdao City, Shandong Province (CN); MIAOMIAO XUE, Qingdao City, Shandong Province (CN); YUZHUO ZHANG, Qingdao City, Shandong Province (CN); QIN DONG, Qingdao City, Shandong Province (CN); GANGJUN QI, Qingdao City, Shandong Province (CN)

(21) Appl. No.: 16/474,542

(22) PCT Filed: May 12, 2017
(86) PCT No.: PCT/CN2017/084164

§ 371 Date: Jun. 27, 2019

(30) Foreign Application Priority Data
Dec. 27, 2016 (CN) 201611226271.4

(51) Int. Cl. F25D 23/02; F25D 29/00; F25D 11/02; H04R 1/02

(52) U.S. Cl. CPC F25D 23/028; F25D 29/005; F25D 2323/02; H04R 1/026; F25D 11/02

(57) ABSTRACT

The present invention provides a refrigerating and freezing device, including a cabinet and a door body provided on the cabinet for opening or closing the cabinet, wherein the door body includes a first door body and a second door body spaced apart from each other. In a closed state, the first door body and the second door body are located on the same plane. The first door body is provided with a sound generating device on a side facing the second door body, and the direction of the sound emitted by the sound generating device faces the second door body. A gap serving as a sound mixing chamber is formed between the first door body and the second door body. Therefore, the sound emitted by the sound generating device can be reflected back and forth in the sound mixing chamber, thereby making the sound more pleasant and vigorous.

The present application claims the priority of Chinese patent application No. 201611226271.4, filed on Dec. 27, 2016 and titled “Refrigerating and Freezing Device”, which is incorporated herein by reference in its entirety.

### TECHNICAL FIELD

The present invention provides a refrigerating and freezing device and particularly relates to a refrigerating and freezing device whose door body is provided with a sound generating device.

### BACKGROUND

With the development of science and technology and the improvement in people's living standards, there is an increasingly higher requirement on home appliances. People have begun to be unsatisfied with the functions of home appliances per se, and have higher requirements on the use comfortability of the home appliances. As the intelligence of refrigerators is improved, most refrigerators are equipped with loudspeakers which give voice prompts to add fun. However, the loudspeaker usually makes sounds directly outwards. As a consequence, the sound quality of the loudspeaker is relatively poor. The sound when the door is opened or closed is not pleasant enough to meet the needs of consumers. However, if a more sophisticated loudspeaker is used, the cost will rise accordingly.

Therefore, it is necessary to design a refrigerating and freezing device which is relatively low in cost and provided with a sound generating device on a door body.

### SUMMARY

Aiming at the problems existing in the prior art, an object of the present invention is to provide a refrigerating and freezing device having a lower cost and having a sound generating device provided on a door body.

In order to achieve the above object, the present invention provides a refrigerating and freezing device which includes a cabinet and a door body provided on the cabinet for opening or closing the cabinet. The door body includes a first door body and a second door body spaced apart from each other. In a closed state, the first door body and the second door body are located on the same plane. The first door body is provided with a sound generating device on a side facing the second door body. The sound output direction of the sound generating device faces the second door body. A gap serving as a sound mixing chamber is formed between the first door body and the second door body.

As an improvement of the present invention, the width of the gap is in the range of 8 mm to 16 mm.

As a further improvement of the present invention, the first door body is recessed in a direction away from the second door body to form a cavity, and the sound generating device is disposed in the cavity.

As a further improvement of the present invention, the side of the second door body adjacent to the first door body is a plane.

As a further improvement of the present invention, the sound generating device includes a sound generating unit, and the sound generating unit forms a primary sound chamber with the cavity. The primary sound chamber is formed on a side of the sound generating unit away from the second door body.

As a further improvement of the present invention, the door body further includes a cover plate for covering the cavity, and a secondary sound chamber is formed between the sound generating unit and the cover plate.

As a further improvement of the present invention, the cover plate is provided with a plurality of sound output holes.

As a further improvement of the present invention, the first door body includes a lower trim strip which is internally recessed to form the cavity.

As a further improvement of the present invention, the first door body and the second door body are arranged in a vertical direction.

The present invention has the following beneficial effects: the first door body and the second door body are located on the same plane in the closed state, so that when the sound generating device of the first door body generates a sound, the sound can be emitted from the sound mixing chamber between the first door body and the second door body. Accordingly, the generated sound is more pleasant and vigorous.

### BRIEF DESCRIPTION OF THE DRAWINGS

FIG. 1 is a front view of the door body of the refrigerating and freezing device of the present invention.

FIG. 2 is a side view of the door body of the refrigerating and freezing device of the present invention.

FIG. 3 is an enlarged structural diagram of the circled portion of FIG. 2.

FIG. 4 is a bottom view of the lower trim strip of the door body of the refrigerating and freezing device of the present invention.

FIG. 5 is a section view taken along line A-A′ of FIG. 4.

### DETAILED DESCRIPTION

The present invention will be described in detail below in conjunction with various embodiments shown in the drawings. However, these embodiments do not limit the present invention, and structural or functional changes made by an ordinary person skilled in the art based on these embodiments are included in the protection scope of the present invention.

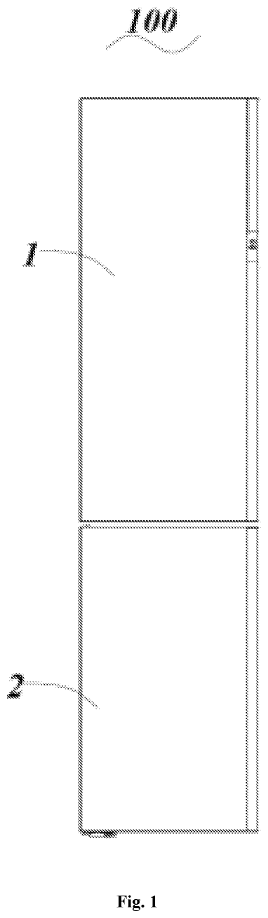

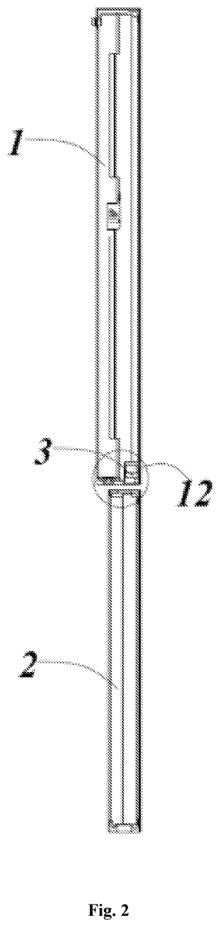

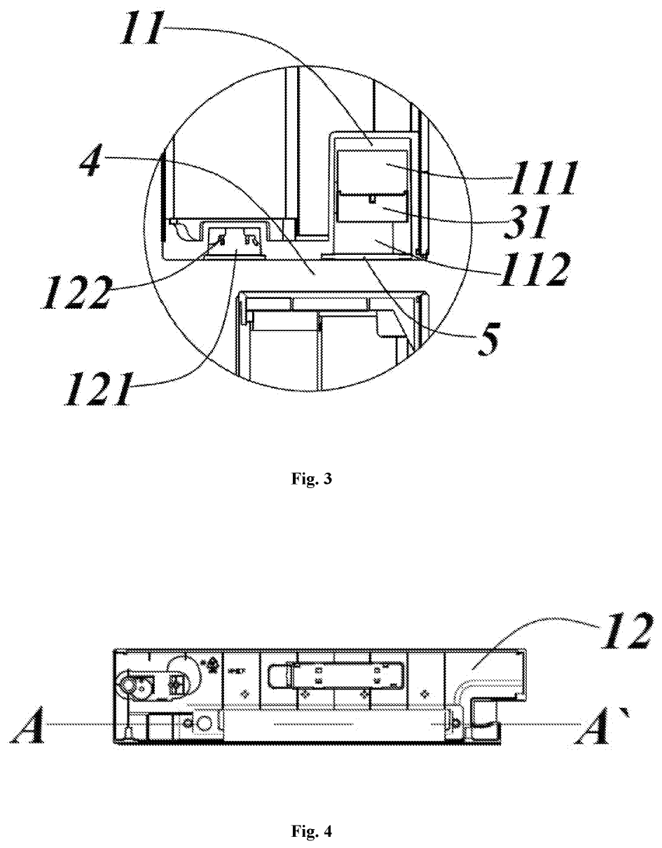

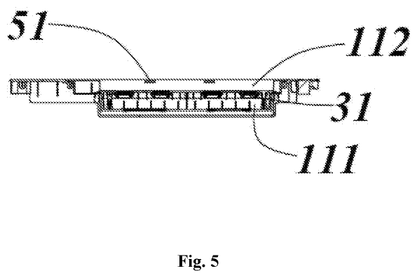

As shown in FIGS. 1 to 5, the present invention provides a refrigerating and freezing device including a cabinet and a door body 100 provided on the cabinet for opening or closing the cabinet. In the present embodiment, the refrigerating and freezing device refers to a refrigerator.

The door body 100 includes a first door body 1 and a second door body 2 which are spaced apart from each other. In a closed state, the first door body 1 and the second door body 2 are located on the same plane. The first door body 1 is provided with a sound generating device 3 on a side facing the second door body 2, and the direction of the sound emitted by the sound generating device 3 faces the second door body 2. A gap 4 serving as a sound mixing chamber is formed between the first door body 1 and the second door body 2. Therefore, the sound emitted by the sound generating device 3 can be reflected back and forth in the sound mixing chamber, thereby making the sound more pleasant and vigorous. The width of the gap 4 is in the range of 8 mm to 16 mm. Preferably, in the present embodiment, the width of the gap 4 is 13 mm to achieve the best effect of sound reflection.

In the present embodiment, the side of the second door body 2 adjacent to the first door body 1 is a plane, and the side of the first door body 1 adjacent to the second door body 2 is also a plane, which is thus equivalent to that the gap 4 is opened to the outside. Therefore, even if the sound emitted by the sound generating device 3 is reflected back and forth in the gap 4, the case of a dull sound will not be caused. Rather, the sound is generated gradually outwards, making the sound more pleasant.

The first door body 1 is recessed in a direction away from the second door body 2 to form a cavity 11. The sound generating device 3 is disposed in the cavity 11. Moreover, the door body 100 further includes a cover plate 5 for covering the cavity 11, so that the cover plate 5 and the cavity 11 form a receiving space for receiving the sound generating device 3.

The sound generating device 3 includes a sound generating unit 31. A primary sound chamber 111 is formed between the sound generating unit 31 and the cavity 11. The primary sound chamber 111 is formed on a side of the sound generating unit 31 away from the second door body 2. Of course, a secondary sound chamber 112 is formed between the sound generating unit 31 and the cover plate 5. Thus, the primary sound chamber 111 and the secondary sound chamber 112 are respectively formed on two sides of the sound generating device 3. And the direction of the sound emitted by the sound generating unit 31 faces the cover plate 5. The primary sound chamber 111 and the secondary sound chamber 112 have the same function, both for improving the sound effect. Of course, the cover plate 5 is provided with sound holes 51 to facilitate the sound emitting by the sound generating unit 31. Of course, as described above, the cover plate 5 is also a plane. In addition, the sound generating unit 31 is a loudspeaker.

In the present embodiment, the door body 100 includes a lower trim strip 12 which is internally recessed to form the cavity 11. The sound generating device 3 is disposed in the cavity 11. Therefore, the sound generating device 3 is not provided in a foam layer of the door body 100, and thus is also easy to be installed and maintained. In addition, the lower trim strip 12 is internally recessed to form a recess 121. An LED lamp 122 is installed in the recess 121 for illumination.

Of course, the door body 100 further includes a front door panel, a rear door panel, an upper trim strip, and two side trim strips. Before foaming, the upper trim strip, the lower trim strip 12 and the two side trim strips are fixed to the front door panel and the rear door panel by clamping, and then the foam is filled between the front door panel and the rear door panel. After the foaming is finished, install the sound generating unit 31 into the cavity 11, so that the sound generating unit 31 can be installed after the door body 100 is foamed. Thus the installation, maintenance, and the like of the sound generating unit 31 are more convenient.

In addition, in the present embodiment, the first door body 1 and the second door body 2 are arranged in a vertical direction. Generally, the first door body 1 and the second door body 2 are a refrigerating chamber door body 100 and a freezing chamber door body 100, respectively.

In summary, the refrigerating and freezing device of the present invention adopts the first door body 1 and the second door body 2, and the sound mixing gap 4 is provided between the first door body 1 and the second door body 2, so that the sound emitted by the sound generating device 3 in the first door body 1 is reflected between the first door body 1 and the second door body 2 and thus the sound is more pleasant and vigorous. Moreover, since the sound mixing gap 4 is provided on the first door body 1, when the door is opened or closed, the sounds are different. Thus, the fun of life is further increased without increasing the cost. Further, the second door body 2 may also be provided with the sound generating device 3 as described above, so that when the second door body 2 is opened or closed, the same effect as the first door body 1 described above can be achieved.

It should be understood that although the description is described based on the embodiments, not every embodiment merely includes one independent technical solution. The statement mode of the description is merely for clarity, and those skilled in the art shall regard the description as a whole. The technical solutions in all of the embodiments may also be combined as appropriate to form other embodiments that can be understood by those skilled in the art.

The detailed description set forth above merely aims to specifically illustrate the feasible embodiments of the present invention, and is not intended to limit the protection scope of the present invention. Equivalent implementations or modifications made without departing from the technical spirit of the present invention will be included within the protection scope of the present invention.

What is claimed is:

1. A refrigerating and freezing device, comprising a cabinet and a door body provided on the cabinet for opening or closing the cabinet, wherein the door body comprises a first door body and a second door body spaced apart from each other; in a closed state, the first door body and the second door body are located on the same plane; the first door body is provided with a sound generating device on a side facing the second door body, and the direction of the sound emitted by the sound generating device faces the second door body; and a gap serving as a sound mixing chamber is formed between the first door body and the second door body.

2. The refrigerating and freezing device according to claim 1, wherein the width of the gap is in the range of 8 mm to 16 mm.

3. The refrigerating and freezing device according to claim 1, wherein a side of the second door body adjacent to the first door body is a plane.

4. The refrigerating and freezing device according to claim 1, wherein the first door body is recessed in a direction away from the second door body to form a cavity, and the sound generating device is disposed in the cavity.

5. The refrigerating and freezing device according to claim 4, wherein the sound generating device comprises a sound generating unit, the sound generating unit forms a primary sound chamber with the cavity, and the primary sound chamber is formed on a side of the sound generating unit away from the second door body.

6. The refrigerating and freezing device according to claim 4, wherein the door body further comprises a cover plate for covering the cavity, and a secondary sound chamber is formed between the sound generating unit and the cover plate.

7. The refrigerating and freezing device according to claim 6, wherein the cover plate is provided with a plurality of sound holes.

8. The refrigerating and freezing device according to claim 4, wherein the first door body comprises a lower trim strip which is internally recessed to form the cavity.

9. The refrigerating and freezing device according to claim 1, wherein the first door body and the second door body are arranged in a vertical direction.
